(19) United States
(12) Patent Application Publication
(10) Pub. No.: US 2014/0063684 A1
(43) Pub. Date: Mar. 6, 2014

(54) CONDUCTIVE PASTE COMPOSITION FOR EXTERNAL ELECTRODE, MULTILAYERED CERAMIC COMPONENT INCLUDING THE SAME AND MANUFACTURING METHOD THEREOF

(71) Applicant: SAMSUNG ELECTRO-MECHANICS CO., LTD., Suwon-si (KR)

(72) Inventors: Kyu Ha LEE, Suwon-si (KR); Chang Joo LEE, Suwon-si (KR); Jae Hwan HAN, Suwon-si (KR); Hye Seong KIM, Suwon-si (KR); Chang Hoon KIM, Suwon-si (KR); Hyun Hee GU, Suwon-si (KR); Kyung Pyo HONG, Suwon-si (KR); Sung Koo KANG, Suwon-si (KR); Byoung Jin CHUN, Suwon-si (KR); Byung Jun JEON, Suwon-si (KR)

(73) Assignee: SAMSUNG ELECTRO-MECHANICS CO., LTD., Suwon-si (KR)

(21) Appl. No.: 13/723,029

(22) Filed: Dec. 20, 2012

(30) Foreign Application Priority Data
Sep. 3, 2012 (KR) 10-2012-0096997

(51) Int. Cl. H01G 4/30

(52) U.S. Cl. CPC H01G 4/30
USPC 361/301.4; 252/512; 252/514; 156/89.18; 156/89.17

(57) ABSTRACT

There is provided conductive paste composition for an external electrode including: a first metal powder particle having a spherical shape and formed of a fine copper; and a second metal powder particle coated on a surface of the first metal powder particle and having a melting point lower than that of the copper.

### CROSS-REFERENCE TO RELATED APPLICATIONS

This application claims the priority of Korean Patent Application No. 10-2012-0096997 filed on Sep. 3, 2012, in the Korean Intellectual Property Office, the disclosure of which is incorporated herein by reference.

### BACKGROUND OF THE INVENTION

1. Field of the Invention

The present invention relates to a conductive paste composition for an external electrode, a multilayered ceramic electronic component including the same, and a manufacturing method thereof.

2. Description of the Related Art

As representative electronic components using a ceramic material, there may be provided a capacitor, an inductor, a piezoelectric element, a varistor, a thermistor, and the like.

Among ceramic electronic components, a multilayered ceramic capacitor (MLCC) includes a ceramic body formed of a ceramic material, internal electrodes formed within the ceramic body, and external electrodes provided on surfaces of the ceramic body so as to be electrically connected to the internal electrodes. In addition, the MLCC is relatively small, secures high capacitance, and is easily mounted on a substrate.

Due to the above-mentioned advantages, multilayered ceramic capacitors are mounted on printed circuit boards of various electronic products such as computers, personal digital assistants (PDAs), cellular phones, and the like, to be used as chip-shaped condensers serving an important role such as charging or discharging electricity. In addition, MLCCs may have various sizes and multilayered shapes according to a used usage, capacitance, or the like.

In accordance with the recent trend for the miniaturization of electronic products, an extremely small-sized MLCC having high capacitance has been demanded. To this end, a multilayered ceramic capacitor having a structure in which each thickness of dielectric layers and internal electrodes becomes thinned and more dielectric layers and internal electrodes are multilayered has been manufactured.

Since many devices manufactured in technical fields demanding a high degree of reliability such as the automotive field, the medical equipment field, or the like, have been digitalized, an extremely small-sized MLCC having super-high capacitance has been also demanded to have a high degree of reliability.

As a factor causing a problem in attaining a high degree of reliability, a radial crack may be generated in the ceramic body due to a side effect resulting from the dielectric layer and the internal electrode having an increased number of thinned, stacked layers. In the case in which the crack is serious, the crack may be propagated to a portion in which the internal electrode is formed to deteriorate the reliability of the product.

In general, the crack of the ceramic body is usually generated because at the time of firing the external electrodes, a copper component of the external electrode is diffused to a nickel component of the internal electrode due to a difference in a diffusion rate while forming a copper-nickel (Cu—Ni) alloy, such that volume of the internal electrode is expanded, and stress is applied to the dielectric layer due to the expansion in volume of the internal electrode.

### SUMMARY OF THE INVENTION

An aspect of the present invention provides a conductive paste composition for an external electrode capable of decreasing the occurrence of a radial crack, and a multilayered ceramic electronic component including the same.

According to an aspect of the present invention, there is provided a conductive paste composition for an external electrode including: a first metal powder particle having a spherical shape and formed of a fine copper; and a second metal powder particle coated on a surface of the first metal powder particle and having a melting point lower than that of the copper.

The first metal powder particle may have a size of 0.1 to 1.5 μm.

The second metal powder particle may be at least one selected from a group consisting of silver (Ag), tin (Sn), and aluminum (Al).

The second metal powder may be at least one selected from the group consisting of silver (Ag), tin (Sn), and aluminum (Al).

According to another aspect of the present invention, there is provided a multilayered ceramic electronic component including: a ceramic body in which a plurality of dielectric layers are stacked; a plurality of first and second internal electrodes formed on at least one surface of the dielectric layers and alternately exposed through both end surfaces of the ceramic body; and first and second external electrodes formed on the both end surfaces of the ceramic body and electrically connected to the first and second internal electrodes, wherein the first and second external electrodes may be obtained by firing a conductive paste including a first metal powder particle having a spherical shape and formed of a fine copper and a second metal powder particle coated on a surface of the first metal powder particle and having a melting point lower than that of the copper.

A densification of the first and second external electrodes may be implemented from 700° C. at the time of a firing process.

The multilayered ceramic electronic component may further include first and second plating layers formed on surfaces of the first and second external electrodes.

The first and second plating layers may include a nickel (Ni) plating layer formed on surfaces of the first and second external electrodes and a tin (Sn) plating layer formed on a surface of the Ni plating layer.

According to another aspect of the present invention, there is provided a method of manufacturing a multilayered ceramic electronic component, the method including: preparing a plurality of ceramic sheets; forming first and second internal electrode patterns on the ceramic sheets; forming a laminate by stacking the ceramic sheets having the first and second internal electrode patterns formed thereon; forming a ceramic body by cutting the laminate such that respective one ends of the first and second internal electrode patterns are alternately exposed through both end surfaces of the laminate and firing the cut laminate; forming first and second external electrode patterns on the both end surfaces of the ceramic body so as to be electrically connected to exposed portions of the respective first and second internal electrode patterns by using a conductive paste for an external electrode, the conductive paste including a first metal powder particle having a spherical shape and formed of a fine copper and a second metal powder particle coated on a surface of the first metal powder particle and having a melting point lower than that of the copper; and forming first and second external electrodes by firing the first and second external electrode patterns.

The method may further include, after the forming of the first and second external electrodes, forming first and second plating layers by sequentially plating nickel (Ni) and tin (Sn) on surfaces of the first and second external electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a multilayered ceramic capacitor according to an embodiment of the present invention;

FIG. 2 is a cross-sectional view taken along line A-A′ of FIG. 1;

FIGS. 3A and 3B are views illustrating packing structures of a paste for an external electrode according to a size and a form of a copper powder, respectively;

FIGS. 4A through 4C are photographs illustrating cross-sectional microstructures of external electrodes according to amounts of silver coated as a second metal powder used in the paste for an external electrode, respectively;

FIG. 5 is a graph illustrating general states of copper and silver according to temperature, respectively;

FIGS. 6A and 6B are photographs illustrating cross-sectional microstructures of external electrodes of a multilayered ceramic capacitor using a paste for an external electrode according to the related art, respectively;

FIGS. 6C and 6D are photographs illustrating cross-sectional microstructures of external electrodes of the multilayered ceramic capacitor using the paste for an external electrode of the present embodiment, respectively; and

FIG. 7 is a view schematically illustrating a firing process for a general material.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

The present invention relates to a ceramic electronic component, and the ceramic electronic component according to an embodiment of the present invention may be a multilayered ceramic capacitor, an inductor, a piezoelectric element, a varistor, a chip resistor, a thermistor, or the like. Hereinafter, the multilayered ceramic capacitor will be described as an example of the ceramic electronic component.

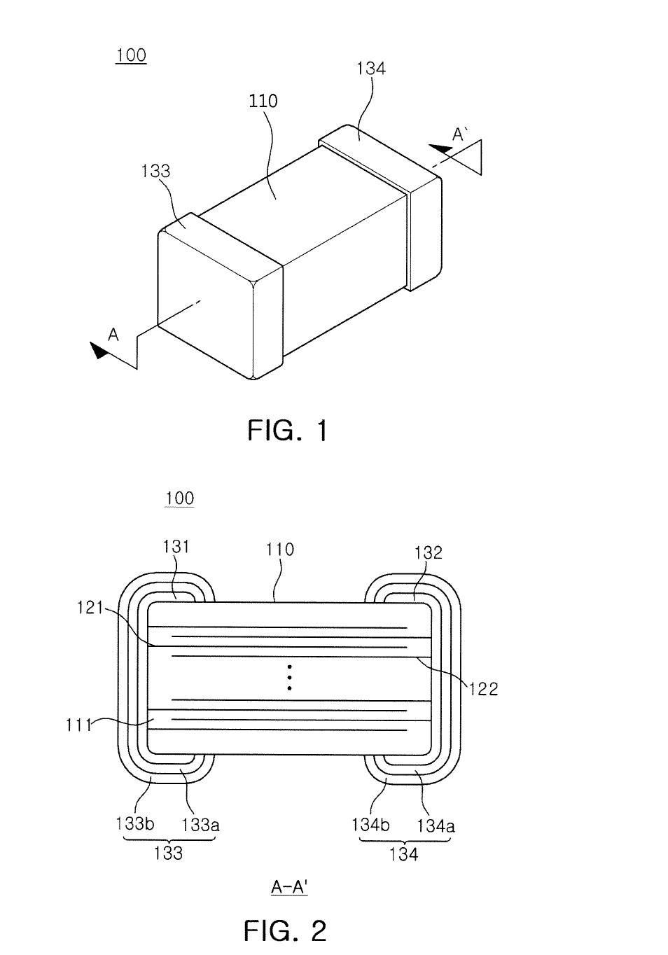

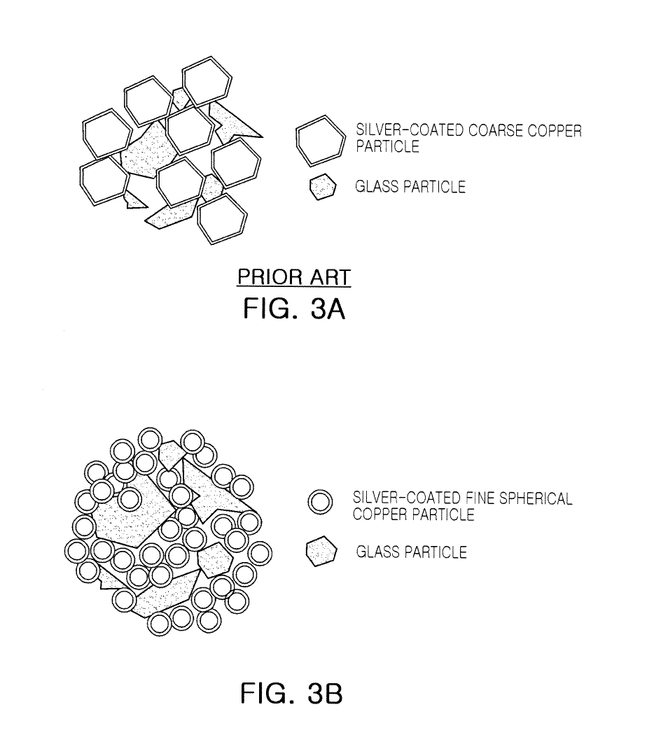

Referring to FIGS. 1 and 2, a multilayered ceramic capacitor 100 according to the present embodiment may include a ceramic body 110 in which a plurality of dielectric layers 111 are stacked; a plurality of first and second internal electrodes 121 and 122 formed on at least one surface of the dielectric layers 111; and first and second external electrodes 131 and 132 formed on both end surfaces of the ceramic body 110 and electrically connected to the first and second internal electrodes 121 and 122.

The ceramic body 110 may be formed by stacking the plurality of dielectric layers 111 and performing firing thereon. Here, the plurality of dielectric layers configuring the ceramic body 110 may be integrated such that a boundary between dielectric layers adjacent to each other may not be readily discernible.

In addition, the ceramic body 110 may generally have a rectangular parallelepiped shape, but is not limited thereto.

Further, the ceramic body 110 is not specifically limited in dimensions. For example, the ceramic body 110 may have a size of 0.6 mm×0.3 mm, or the like, to thereby manufacture the multilayered ceramic capacitor having high capacitance.

In addition, the ceramic body 110 may include a dielectric cover layer (not shown) having a predetermined thickness formed on the outermost surface thereof, if needed.

A thickness of each dielectric layer 111 contributing to forming capacitance of the capacitor may be appropriately changed according to a capacitance design of the multilayered ceramic capacitor. Preferably, a thickness of each dielectric layer 111 after a firing process may be set to be 0.1 to 1.0 μm; however, the present invention is not limited thereto.

In addition, the dielectric layer 111 may include a ceramic material having high dielectric constant, for example, a BaTiO₃-based ceramic powder, or the like. However, the present invention is not limited thereto.

An example of the BaTiO₃-based ceramic powder may have (Ba₁₋ₓCaₓ) TiO₃, Ba(Ti_{1-y}Ca_{y})O₃, (Ba₁₋ₓCaₓ)(Ti_{1-y}Zr_{y})O₃, or Ba(Ti_{1-y}Zr_{y})O₃, or the like, having Ca, Zr, or the like, partially employed in BaTiO₃, but is not limited thereto.

Meanwhile, in addition to the ceramic powder, a transition metal oxide or carbide, a rare-earth element, various ceramic additives such as Mg, Al, and the like, an organic solvent, a plasticizer, a binder, a dispersant, or the like, may be added to the dielectric layer 111.

The first and second internal electrodes 121 and 122 may be stacked on a ceramic sheet forming the dielectric layer 111, and formed within the ceramic body 110 having each dielectric layer 111 interposed therebetween by performing a firing process.

The first and second internal electrodes 121 and 122, pairs of electrodes having different polarities, may be disposed to face each other in a stacking direction of the dielectric layer 111 and be electrically insulated from each other by the dielectric layer 111 interposed therebetween.

In addition, respective one ends of the first and second internal electrodes 121 and 122 may be exposed through both end surfaces of the ceramic body 110, and electrically connected to the first and second external electrodes 131 and 132.

The first and second internal electrodes 121 and 122 may be formed of a conductive metal, for example, nickel (Ni), a Ni alloy, or the like. However, the present invention is not limited thereto.

In the case in which a predetermined level of voltage is applied to the first and second external electrodes 131 and 132, an electrical charge is accumulated between the first and second internal electrodes 121 and 122 facing each other. Here, capacitance of the multilayered ceramic capacitor 100 is in proportion to areas of the first and second internal electrodes 121 and 122 facing each other.

The first and second external electrodes 131 and 132 may be formed by using a conductive paste for an external electrode, including a first metal powder particle and a second metal powder particle having a melting point lower than that of the first metal powder particle and coated on a surface of the first metal powder particle. Here, densification of the first and second external electrodes 131 and 132 may be implemented from 700° C. at the time of a firing process.

In the conductive paste for an external electrode, a copper powder particle having a spherical shape and formed of a fine copper may be used as the first metal powder particle; and at least one selected from the group consisting of silver (Ag), tin (Sn), and aluminum (Al) having a melting point lower than that of the copper may be used as the second metal powder particle.

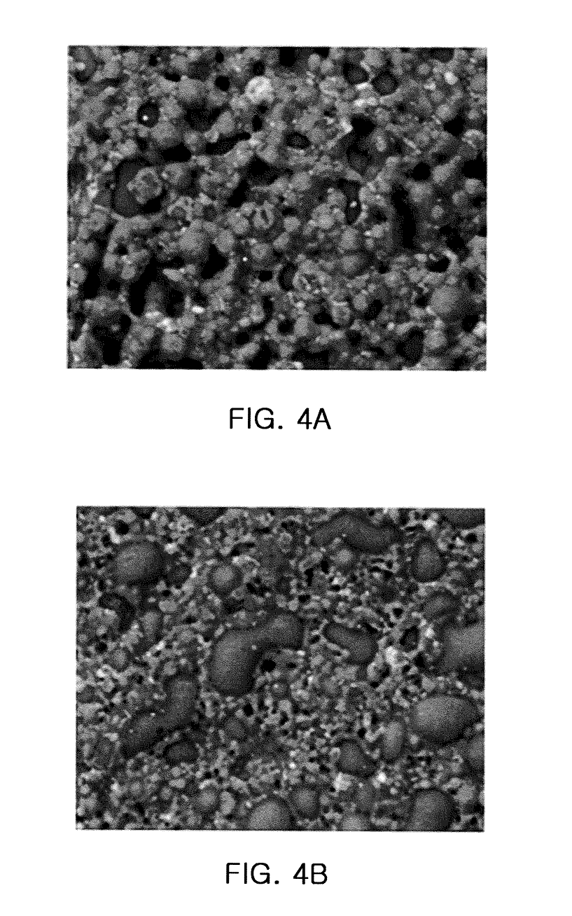

FIGS. 3A and 3B are views illustrating packing structures of a paste for an external electrode according to a size and a form of a copper powder particle, respectively.

Referring to FIGS. 3A and 3B, in the case in which a large amount of copper powder particles having a non-uniform shape are present in the external electrode, dense packing is not possible between a copper powder particle having a high solid content and a glass particle in the paste and a porosity in the paste is increased due to a decrease in density of the packing to thereby deteriorate densification of the external electrode. These defects may be improved by using a fine copper powder particle having a spherical shape as described in the present embodiment.

A size of the first metal powder particle may be preferably 0.1 to 1.5 μm. A detailed description thereof will be described in Table 1 below in detail.

In the conductive paste for an external electrode, the second metal powder particle may be included in a weight ratio of 0.1 to 45.0 based on the first metal powder particle.

In the case in which a content of the second metal powder particle has a weight ratio less than 0.1 based on the first metal powder particle, it may be difficult to control a firing rate, thereby resulting in a deterioration in densification and causing a radial crack in the ceramic body 110.

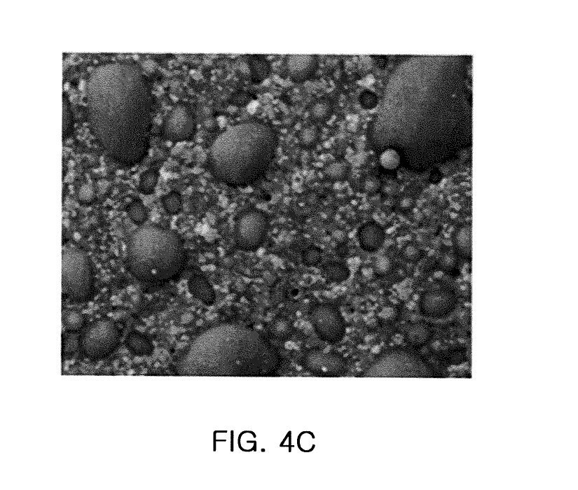

FIG. 4A shows a cross-sectional microstructure of the first and second external electrodes 131 and 132 in the case in which a content of the second metal powder particle has a weight ratio of 10 based on the first metal powder particle, FIG. 4B shows a cross-sectional microstructure of the first and second external electrodes 131 and 132 in the case in which a content of the second metal powder particle has a weight ratio of 30 based on the first metal powder particle, and FIG. 4C shows a cross-sectional microstructure of the first and second external electrodes 131 and 132 in the case in which a content of the second metal powder particle has a weight ratio of 45 based on the first metal powder particle.

Referring to FIGS. 4A through 4C, in the case in which a content of the second metal powder particle has a weight ratio greater than 45 based on the first metal powder particle, that is, the case in which a glass is beaded and a plating is performed on the external electrode in FIG. 4C, the plating may not be performed or an adhesion strength may be reduced.

A conductive paste for an external electrode of the related art may be prepared by mixing a glass frit, a base resin, an organic vehicle produced from an organic solvent, and the like, with a copper powder particle. In the case of forming the external electrode by using the conductive paste for an external electrode of the related art, the number of stacked dielectric layers may be increased. In addition, in the case of forming a thinned product by using the conductive paste for an external electrode of the related art, the radial crack may be generated from the distal end of the ceramic body.

since a diffusion coefficient at which a copper component of the external electrode is diffused to a nickel component of the internal electrode is higher than a diffusion coefficient at which the nickel component is diffused to the copper component by 100 times or more during the firing of the external electrode, the radial crack may be generated in the ceramic body at the time of firing the external electrode.

For example, when comparing diffusion coefficients at a general electrode firing temperature, 780° C., it was confirmed that D (copper to nickel)=5.306×10⁻¹⁶ m²/s, and D (nickel to copper)=5.306×10⁻¹⁸ m²/s and it may be appreciated that a rate in diffusion of the copper to the nickel is superior.

Therefore, in the case in which a copper-nickel alloy is formed at the time of firing the external electrode, due to the difference in diffusion coefficient, the diffusion of copper present in the external electrode to nickel in the internal electrode is generated to thereby cause an expansion in the volume of the internal electrode. Due to the volume expansion of the internal electrode, stress is applied to a dielectric substance to generate the radial crack in the ceramic body, thereby deteriorating reliability of the multilayered ceramic capacitor 100.

However, in the conductive paste for an external electrode of the present embodiment, the second metal powder particle having a melting point lower than that of the first metal powder particle is coated on the first metal powder particle formed of a fine copper, such that a density of the packing in a high solid of the paste is increased by using the fine copper powder particle having a spherical shape.

In addition, due to the addition of the second metal powder particle, a firing temperature is decreased at the time of firing the external electrode to decrease a diffusion rate at which copper is diffused to t nickel, such that the volume expansion of the internal electrode may be suppressed to reduce a generation rate of the radial crack of the ceramic body.

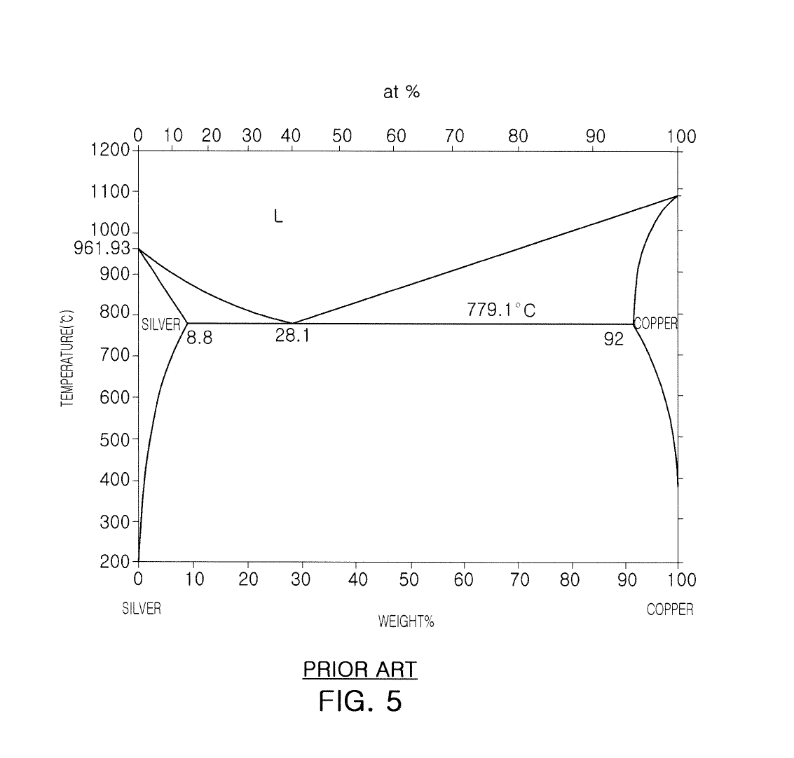

FIG. 5 is a graph illustrating general states of copper and silver according to temperature, respectively. Referring to FIG. 5, it may be appreciated that a melting point of silver is lowered than that of copper by about 120° C., and in the case of a composition having copper of 80 wt % and silver of 20 wt %, the composition has a melting point lower than that of a composition having only copper of 100 wt % by about 100° C.

That is, since a low-temperature firing is possible in the conductive paste for an external electrode by silver coated in the copper powder particle, in the case in which the firing temperature of the external electrode is decreased, it is expected that a diffusion of the copper into the internal electrode may be effectively controlled due to the Arrhenius equation (D=D₀e(−Q/RT, D: diffusion coefficient, D₀: initial rate, Q: activation energy, R: gas constant, T: temperature) illustrating a function of a reaction rate and a temperature of a material, which allows the generation rate of the radial crack of the ceramic body 110 to be decreased.

Meanwhile, first and second plating layers 133 and 134 may be formed on surfaces of the first and second external electrodes 131 and 132, in order to increase the adhesion strength at the time of mounting the multilayered ceramic capacitor 100 on a substrate, or the like.

Here, a plating treatment is performed according to a known method. In consideration of an environment, a lead-free plating is preferably performed; however, the present invention is not limited thereto.

The first and second plating layers 133 and 134 may include a pair of nickel plating layers 133a and 134a formed on respective outer surfaces of the first and second external electrodes 131 and 132 and a pair of tin (Sn) plating layers 133b and 134b formed on respective outer surfaces of nickel plating layers 133a and 134a.

Table 1 below shows a generation rate of a radial crack and a firing temperature at which densification of the external electrode is initiated with respect to the multilayered ceramic capacitor manufactured by the paste for an external electrode prepared according to characteristics of the copper powder particle.

Here, each of the pastes for an external electrode was prepared by adding an organic binder, a dispersant, an organic solvent, and the like, to the metal powder particle listed in Table 1 below and allowing the mixture to be dispersed by using 3-roll-mill to thereby be formed into a paste.

TABLE 1

| | COMPONENT AND | RADIAL CRACK | ELECTRODE FIRING |
|---|---|---|---|
| | SHAPE OF | GENERATION RATE | DENSIFICATION |
| | METAL POWDER | (POPULATION | IMPLEMENTED |
| CLASSIFICATION | PARTICLE | PARAMETER 100 ea) | TEMPERATURE |
| COMPARATIVE | COPPER POWDER | 100% | 850° C. |
| EXAMPLE 1 | PARTICLE OF | | |
| | 3 TO 4 μm | | |
| COMPARATIVE | SIVER-COATED | 100% | 800° C. |
| EXAMPLE 2 | COPPER POWDER | | |
| | PARTICLE OF | | |
| | 3 TO 4 μm | | |
| COMPARATIVE | COPPER POWDER | 48% | 780° C. |
| EXAMPLE 3 | PARTICLE OF | | |
| | 1.5 μm | | |
| INVENTIVE | SILVER-COATED | 0% | 700° C. |
| EXAMPLE 1 | SPHERICAL | | |
| | COPPER POWDER | | |
| | PARTICLE OF | | |
| | 0.3 μm | | |
| INVENTIVE | SILVER-COATED | 0% | 700° C. |
| EXAMPLE 2 | SPHERICAL | | |
| | COPPER POWDER | | |
| | PARTICLE OF | | |
| | 0.5 μm | | |
| INVENTIVE | SILVER-COATED | 8% | 750° C. |
| EXAMPLE 3 | SPHERICAL | | |
| | COPPER POWDER | | |
| | PARTICLE OF | | |
| | 1.5 μm | | |

In Table 1 above, as the second metal powder particle, a pure copper powder particle of 3 to 4 μm, which is not coated with silver, was used in Comparative Example 1, a silver-coated copper powder particle of 3 to 4 μm was used in Comparative Example 2, and a pure copper powder particle of 1.5 μm, which is not coated with silver, was used in Comparative Example 3.

In addition, in Inventive Examples 1 through 3, silver was coated on the file copper powder particle having a spherical shape according to a size thereof. Then, in Comparative Examples 1 through 3, and Inventive Examples 1 through 3, the paste for an external electrode was coated on a chip of 0.6×0.3 mm², and was then fired under a nitrogen atmosphere to form an external electrode. After that, a generation frequency of the radial crack and an electrode firing behavior were examined.

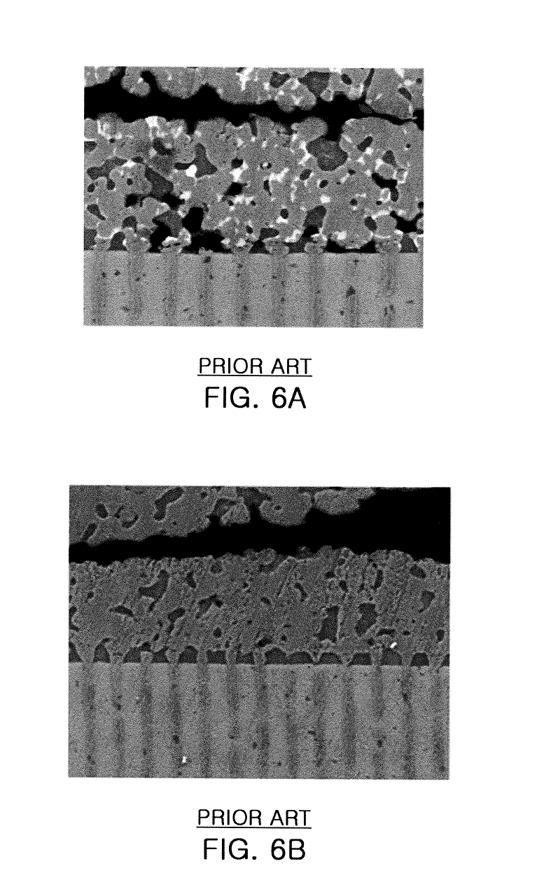

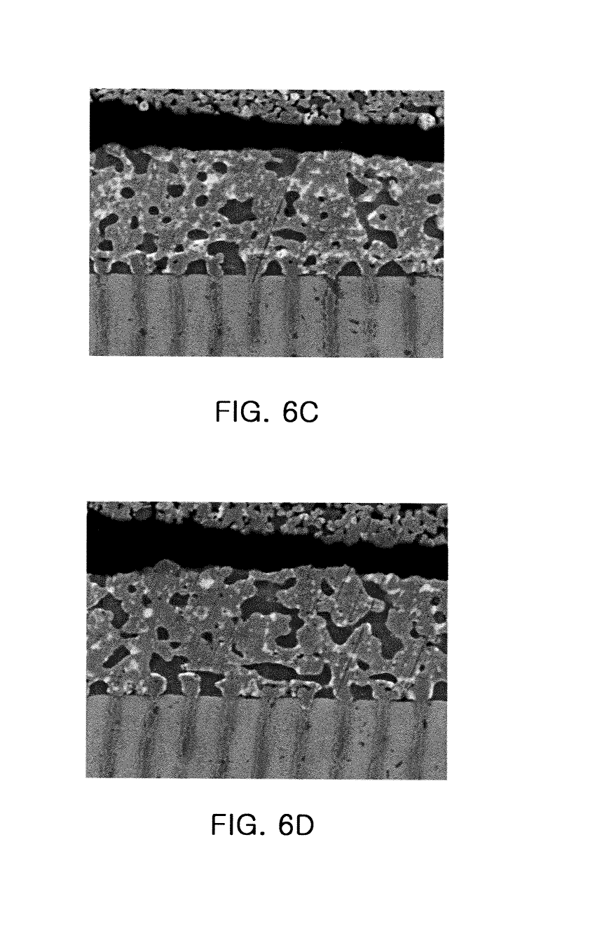

FIGS. 6A through 6D show analysis results of microstructures of the external electrodes by classifying the multilayered ceramic capacitors manufactured by using the pastes for an external electrode prepared in Comparative Examples 1 through 3 and Inventive Examples 1 through 3 listed in Table 1 above according to respective firing temperatures, in order to analyze a reason resulting in the difference in the generation frequency of the radial crack.

FIG. 6A shows a result of Comparative Example 2, FIG. 6B shows a result of Comparative Example 3, FIG. 6C shows a result of Inventive Example 1, and FIG. 6D shows a result of Inventive Example 3.

Referring to Table 1 above, and FIGS. 6A through 6D, it may be appreciated that as the firing temperature at which electrode densification is implemented is decreased, the generation rate of the radial crack is remarkably decreased in Comparative Example 3 using the fine copper powder particle having a spherical shape of 1.5 μm as compared to Comparative Examples 1 and 2 using the copper powder particle having a coarse non-uniform shape.

In addition, it may be appreciated that the firing temperature at which electrode densification is implemented is rapidly decreased in Inventive Examples 1 through 3 using the fine copper powder particle having a spherical shape and silver coated on a surface thereof as the second metal powder particle as compared to Comparative Example 3 using a pure copper powder particle.

Further, it may be appreciated that a size of the copper powder particle having silver coated on a surface thereof is decreased to thereby decrease the generation rate of the radial crack, such that the radial crack was not generated in Inventive Examples 1 and 2.

That is, it may be appreciated that a size of the copper powder particle capable of maintaining uniform reliability of the multilayered ceramic capacitor is preferably 0.1 to 1.5 μm.

In addition, as a result obtained by analyzing the micro-structure of the external electrode per each of the multilayered ceramic capacitors, it may be appreciated that the densification of the external electrode was implemented from at 700° C. or higher in Inventive Examples 1 and 2.

Meanwhile, in Inventive Example 3, the densification of the external electrode was implemented from at 750° C. or higher, and in Comparative Examples 1 through 3, the densification of the external electrode was not implemented even at 750° C.

In particular, in Comparative Example 3 using only the copper powder particle having a spherical shape of 1.5 μm, the densification of the external electrodes 131 and 132 was implemented at 780° C. However, in Comparative Example 2 using the coarse copper powder particle of 3 to 4 μm, even though silver was coated on the surface thereof, the firing temperature at which electrode densification is implemented was 800° C., which is relatively high.

That is, it may be appreciated that in the case of using the fine copper powder particle having a spherical shape and silver coated on the surface thereof as in Inventive Examples 1 through 3, electrode densification was implemented at a firing temperature lower than that of the copper powder particle paste of the related art to thereby decrease an electrode firing temperature.

In addition, it may be appreciated that as the size of the copper powder particle having silver coated thereon is reduced, the densification is rapidly completed to thereby further lower the firing temperature.

Therefore, when the electrode firing temperature is decreased, a diffusion reaction between the copper component of the external electrode and the nickel component of the internal electrode may be insufficiently generated to suppress the generation of radial cracks.

Hereinafter, a manufacturing method of the multilayered ceramic capacitor according to an embodiment of the present invention will be described.

Firstly, a plurality of ceramic sheets are prepared.

In order to form the dielectric layers 111 of the ceramic body 110, ceramic sheets may be produced by mixing ceramic powder, a polymer, a solvent, and the like, to prepare a slurry and the slurry may be formed as sheets of several μm in thickness, using a doctor blade method.

Then, the conductive paste is printed on at least one of each of the ceramic sheets so as to have a predetermined thickness, to thereby form first and second internal electrode patterns.

Here, the first and second internal electrode patterns may be formed so as to be alternately exposed through both end surfaces of the ceramic sheet.

In addition, as an example of printing methods of the conductive paste may include a screen printing method, a gravure printing method, or the like; however, the present invention is not limited thereto.

Then, the plurality of ceramic sheets having the first and second internal electrodes 121 and 122 formed thereon are alternately stacked in plural, and pressurized in a stacking direction. The plurality of ceramic sheets and the first and second internal electrode patterns formed on the plurality of ceramic sheets are compressed to form a laminate.

Next, the laminate is cut into respective regions corresponding to respective capacitors to thereby be formed as chips in such a manner that respective one ends of the first and second internal electrode patterns are alternately exposed through both end surfaces of the laminate.

Then, the respective chips are fired at a high temperature to complete a ceramic body 110 having the plurality of first and second internal electrodes 121 and 122.

Next, first and second external electrode patterns are formed using a conductive paste for an external electrode, on both end surfaces of the ceramic body 110, by covering exposed portions of the first and second internal electrodes 121 and 122 and so as to be electrically connected to the first and second internal electrodes 121 and 122, respectively.

The conductive paste for an external electrode may include the first metal powder particle having a spherical shape and the second metal powder particle having a melting point lower than that of the first metal powder particle and coated on the surface of the first metal powder particle.

As the first metal powder particle, a fine copper powder particle may be used, and the second metal powder particle may be at least one selected from the group consisting of silver (Ag), tin (Sn), and aluminum (Al), which has a melting point lower than that of the copper.

Here, the first metal powder particle may have a size of 0.1 to 1.5 μm. In addition, the second metal powder particle of the conductive paste for an external electrode may be included in a weight ratio of 0.1 to 45.0 based on the first metal powder particle.

Then, the first and second external electrode patterns are fired to complete the multilayered ceramic capacitor 100 having the first and second external electrodes 131 and 132.

The firing of the first and second external electrode patterns may be performed at 600 to 900° C.; however, the present invention is not limited thereto.

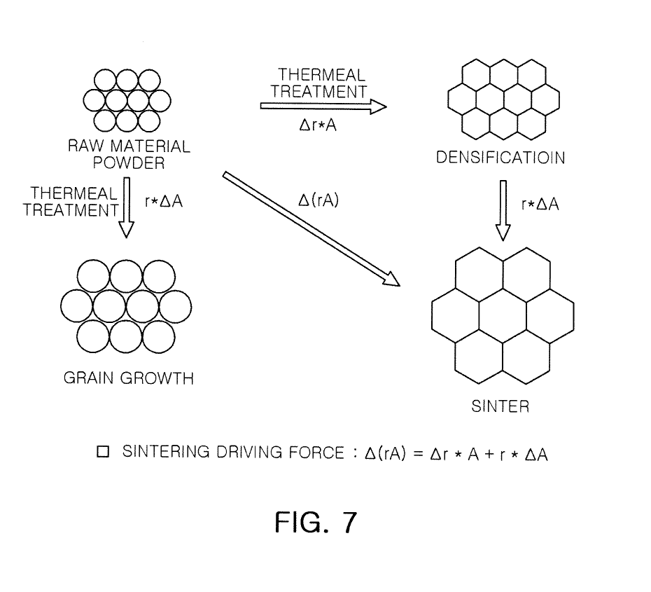

FIG. 7 is a view schematically illustrating a firing process of a general material. Referring to FIG. 7, a firing process of a material includes a densification process for decreasing a surface energy of the material and a grain growth process, and both processes are simultaneously performed by compositively using heat energy.

The densification and the grain growth process are generated due to atomic diffusion, which is accompanied with a movement of a grain boundary, and the atomic diffusion is undertaken in a direction for decreasing the surface energy of the material. As a particle size of a material is smaller, the surface energy is higher, such that a rapid firing behavior of the material may be shown.

As described in the present embodiment, in the case of using the fine copper powder particle having a spherical shape at the time of manufacturing the external electrodes, decreased sintering driving force may be shown due to high surface energy generated due to an increase in surface area of the copper powder particle, and thus dense external electrodes may be implemented.

Then, a plating treatment may be performed on the surfaces of the first and second external electrodes 131 and 132 to thereby further form the first and second plating layers 133 and 134.

Here, a material used in the plating treatment may include nickel or tin, a nickel-tin alloy, and the like. In addition, if needed, the nickel plating layers 133a and 134a and the tin plating layers 133b and 134b may be sequentially stacked on the first and second external electrodes 131 and 132.

As set forth above, according to the embodiments of the present invention, the conductive paste composition for an external electrode includes the first metal powder particle having the spherical shape and formed of a fine copper and the second metal powder particle having a melting point lower than that of the copper and coated on the surface of the first metal powder particle to decrease the firing temperature of the first metal powder particle, whereby the copper powder particle is prevented from being diffused to the nickel component of the internal electrodes at the time of firing the external electrodes, to suppress the radial crack generated due to the volume expansion of the internal electrodes.

While the present invention has been shown and described in connection with the embodiments, it will be apparent to those skilled in the art that modifications and variations can be made without departing from the spirit and scope of the invention as defined by the appended claims.

What is claimed is:

1. A conductive paste composition for an external electrode comprising:
a first metal powder particle having a spherical shape and formed of a fine copper; and
a second metal powder particle coated on a surface of the first metal powder particle and having a melting point lower than that of the copper.

2. The conductive paste composition for an external electrode of claim 1, wherein the first metal powder particle has a size of 0.1 to 1.5 μm.

3. The conductive paste composition for an external electrode of claim 1, wherein the second metal powder particle is included in a weight ratio of 0.1 to 45.0 based on the first metal powder particle.

4. The conductive paste composition for an external electrode of claim 1, wherein the second metal powder particle is at least one selected from a group consisting of silver (Ag), tin (Sn), and aluminum (Al).

5. A multilayered ceramic electronic component comprising:
a ceramic body in which a plurality of dielectric layers are stacked;
a plurality of first and second internal electrodes formed on at least one surface of the dielectric layers and alternately exposed through both end surfaces of the ceramic body; and
first and second external electrodes formed on the both end surfaces of the ceramic body and electrically connected to the first and second internal electrodes,
wherein the first and second external electrodes are obtained by firing a conductive paste including a first metal powder particle having a spherical shape and formed of a fine copper and a second metal powder particle coated on a surface of the first metal powder particle and having a melting point lower than that of the copper.

6. The multilayered ceramic electronic component of claim 5, wherein the first metal powder particle has a size of 0.1 to 1.5 μm.

7. The multilayered ceramic electronic component of claim 5, wherein the second metal powder particle is included in a weight ratio of 0.1 to 45.0 based on the first metal powder particle.

8. The multilayered ceramic electronic component of claim 5, wherein the second metal powder particle is at least one selected from a group consisting of silver (Ag), tin (Sn), and aluminum (Al).

9. The multilayered ceramic electronic component of claim 5, wherein a densification of the first and second external electrodes is implemented from 700° C. at a time of a firing process.

10. The multilayered ceramic electronic component of claim 5, further comprising first and second plating layers formed on surfaces of the first and second external electrodes.

11. The multilayered ceramic electronic component of claim 10, wherein the first and second plating layers include a nickel (Ni) plating layer formed on surfaces of the first and second external electrodes and a tin (Sn) plating layer formed on a surface of the Ni plating layer.

12. A method of manufacturing a multilayered ceramic electronic component, the method comprising:
preparing a plurality of ceramic sheets;
forming first and second internal electrode patterns on the ceramic sheets;
forming a laminate by stacking the ceramic sheets having the first and second internal electrode patterns formed thereon;
forming a ceramic body by cutting the laminate such that respective one ends of the first and second internal electrode patterns are alternately exposed through both end surfaces of the laminate and firing the cut laminate;
forming first and second external electrode patterns on the both end surfaces of the ceramic body so as to be electrically connected to exposed portions of the respective first and second internal electrode patterns by using a conductive paste for an external electrode, the conductive paste including a first metal powder particle having a spherical shape and formed of a fine copper and a second metal powder particle coated on a surface of the first metal powder particle and having a melting point lower than that of the copper; and
forming first and second external electrodes by firing the first and second external electrode patterns.

13. The manufacturing method of claim 12, wherein in the forming of the first and second external electrode patterns, the first metal powder particle of the conductive paste for an external electrode has a size of 0.1 to 1.5 μm.

14. The manufacturing method of claim 12, wherein in the forming of the first and second external electrode patterns, the second metal powder particle of the conductive paste for an external electrode is included in a weight ratio of 0.1 to 45.0 based on the first metal powder particle.

15. The manufacturing method of claim 12, wherein in the forming of the first and second external electrode patterns, the second metal powder particle of the conductive paste for an external electrode is at least one selected from a group consisting of silver (Ag), tin (Sn), and aluminum (Al).

16. The manufacturing method of claim 12, further comprising, after the forming of the first and second external electrodes, forming first and second plating layers by sequentially plating nickel (Ni) and tin (Sn) on surfaces of the first and second external electrodes.
